(19) United States
(12) Patent Application Publication
(10) Pub. No.: US 2009/0175674 A1
(43) Pub. Date: Jul. 9, 2009

(54) Device at a Binder

(75) Inventors: Tage Haraldsson, Smalandsstenar (SE); Tore Haraldsson, Smalandsstenar (SE); Inge Andersson, Smalandsstenar (SE)

Correspondence Address: POTOMAC PATENT GROUP PLLC, P. O. BOX 270, FREDERICKSBURG, VA, 22404, US

(73) Assignee: KEBA Sweden AB, Smalandsstenar (SE)

(21) Appl. No.: 12/333,516

(22) Filed: Dec. 12, 2008

(30) Foreign Application Priority Data
Dec. 12, 2007 (SE) 0702755-0

(51) Int. Cl. B42F 13/22

(52) U.S. Cl. 402/36; 402/75

(57) ABSTRACT

A device for fastening prongs in binders, where the prongs are secured to a prong plate arranged to be fastened to the inner sections of a binder spine. Fastening mechanisms are arranged in rows along the binder spine sections. The fastening mechanisms are releasably connectable to supplementary fastening devices located on the respective prong plates. A device for fastening binder sides is also disclosed.

This invention relates to a device for fastening prongs in binders, which is arranged to be fastened to the inner section of a binder spine where the prongs are fastened to a prong plate.

### BACKGROUND

This application claims priority from Sweden Patent Application No. 0702755-0 filed on Dec. 12, 2007, which is incorporated here by reference.

Environmentally binders are not normally easy to recycle because they consist of different materials, e.g., plastic, metal, cardboard, etc. Dismantling the same is cumbersome and expensive, which means that in most cases they are disposed of in general refuse and burnt, which is environmentally harmful and a waste of materials, instead of it being possible to recycle each of the materials in the binder.

Binder prongs are normally formed of metal, which requires surface treatment, which in turn may be environmentally harmful due to the use of various chemical agents.

Rivets, which are used, among other things, to secure the prong mechanism in the binders, may become fouled even in contact with adjacent objects, e.g., other binders, etc., so that discoloration from the metal in the rivets, e.g., aluminum, was possible. Metal in the binders gives rise to an increase in the weight of the binders the greater their metal content. If the metal can be replaced by plastic this also means a considerable saving in weight and is also more economical.

The standard for binders and its prongs varies from one country to another. In order to be able to use many parts together when producing binders, an attempt has been made to solve this problem, or fastening mechanisms have been dispensed with altogether if the binder is intended to be used as an archive box.

It is shown by International Publication WO 83/03388, for example, how prongs (32, 34) and associated fastening plates (31, 33) are secured in longitudinal channel-shaped grooves by means of a fastening mechanism (31, 33), which is bulky.

### SUMMARY

An object of the present invention is therefore primarily to solve the problem of metal in a binder simply and effectively, and to solve the problem of releasably being able to secure the fastening mechanism of the binder for punched papers and other similar objects required to be stored in the binder by means of prongs which project from and are secured to a plate in the spine of the binder.

The objects are achieved by a device having fastening mechanisms arranged in a row along the binder spine sections that can be releasably connected to supplementary fastening means mounted on the respective prong plates.

A further object of the present invention is therefore also to be able to solve the problems simply and effectively. This object is achieved by a device having sections arranged in a row along the binder spine, and fastening mechanisms which are releasably connectable to supplementary fastening means located on the respective prong plate. The fastening mechanisms arranged along the binder spine sections are distributed along the height-adapted prong plates of the binder so that they are positioned optionally at the required level along the binder spine so that fastening mechanisms and fastening means interacting with each other whilst continuing to connect the required number of prong plates at the required levels.

Yet a further object of the present invention is to use ideas involving releasable fastening of binder sides to a common binder spine with fastening means that can be integrated with the binder sides and binder spine and can be easily secured by displacing binder sides and binder spine relative to each other in the intended vertical extension of the binder.

The further object is achieved by a device having fastening mechanisms arranged in a row along the binder spine sections, which mechanisms can be releasably connected to supplementary fastening means located on the respective binder side.

### BRIEF DESCRIPTION OF THE DRAWINGS

The invention is described below as a preferred exemplary embodiment, reference being made to the attached drawings, in which

FIG. 1 shows, in perspective, the inside of a binder in the fully collapsed position, from the inside;

FIG. 2 shows, in perspective, examples of combined binder mechanism prongs;

FIGS. 3 and 4 show examples of the fastening of binder prongs in binders, in different fastening positions;

FIGS. 5, 6, and 7 show side views of the fastening of prongs in binder;

FIGS. 8 and 9 show diagrammatic fastening positions on fully folded out binder sides and side;

FIG. 10 shows examples of the fastening of prongs to a fastening position, in section;

FIGS. 11 and 12 show in greater detail the fastening of the prong mechanism;

FIG. 13 shows a cross-section of a prong mechanism in the finish assembled fastening position;

FIGS. 14, 15, and 16 show examples of fastening binder sides to binder, in different fastening positions viewed along the long side of the binder;

FIGS. 17 and 18 show examples of a fastening position and a method step for fastening viewed from the top of one of the short sides of the binder; and

FIGS. 19 and 20 show further diagrammatic fastening positions on fully folded out binder sides and side.

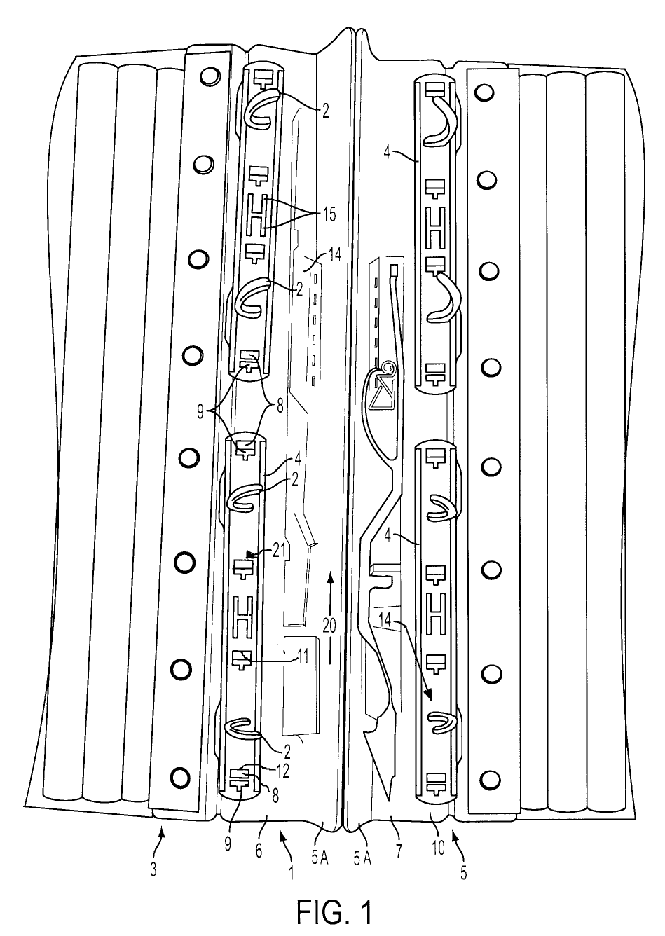

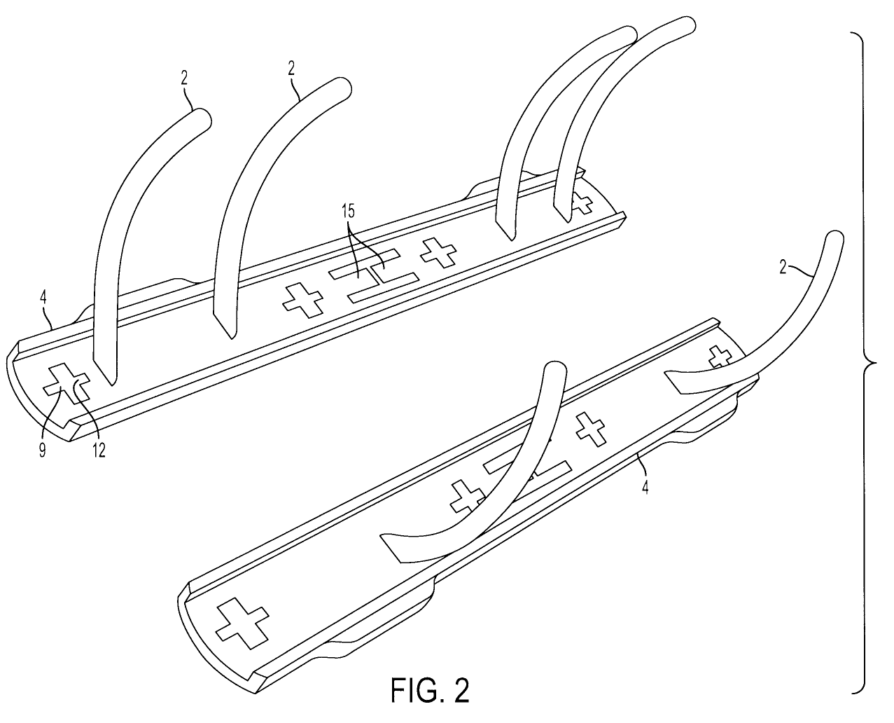

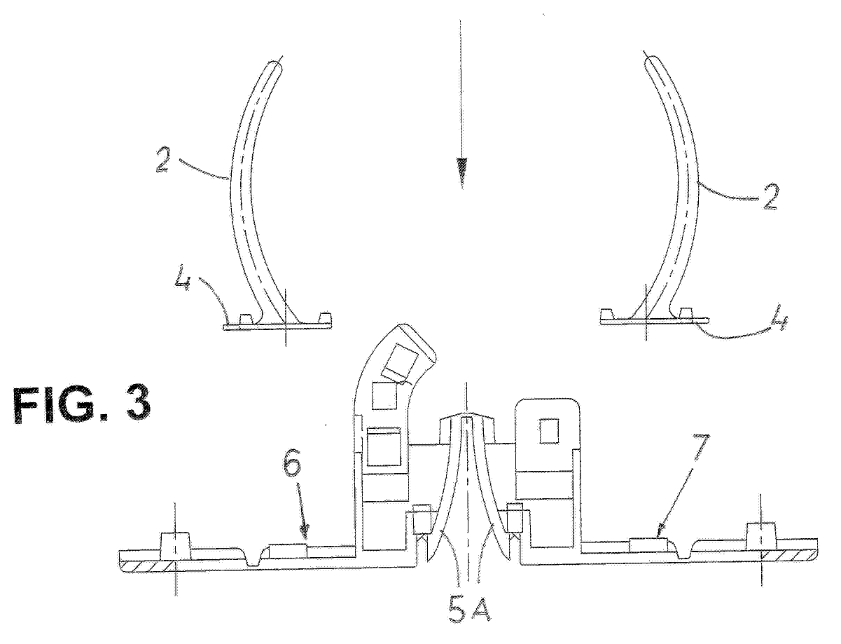

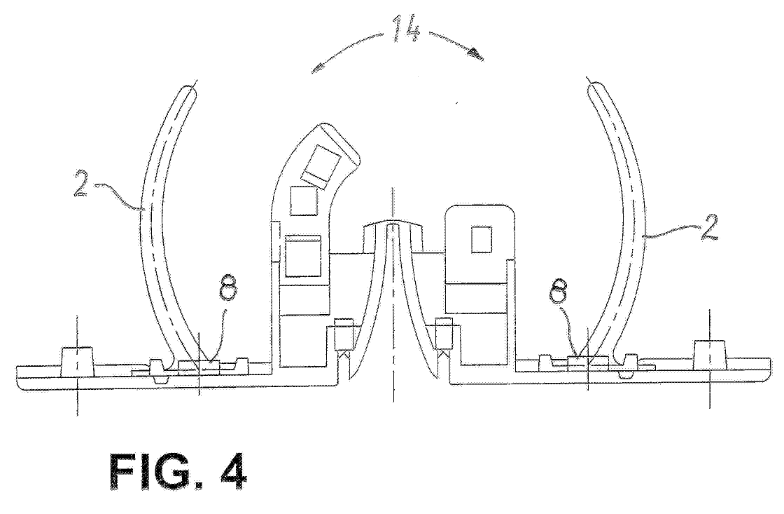

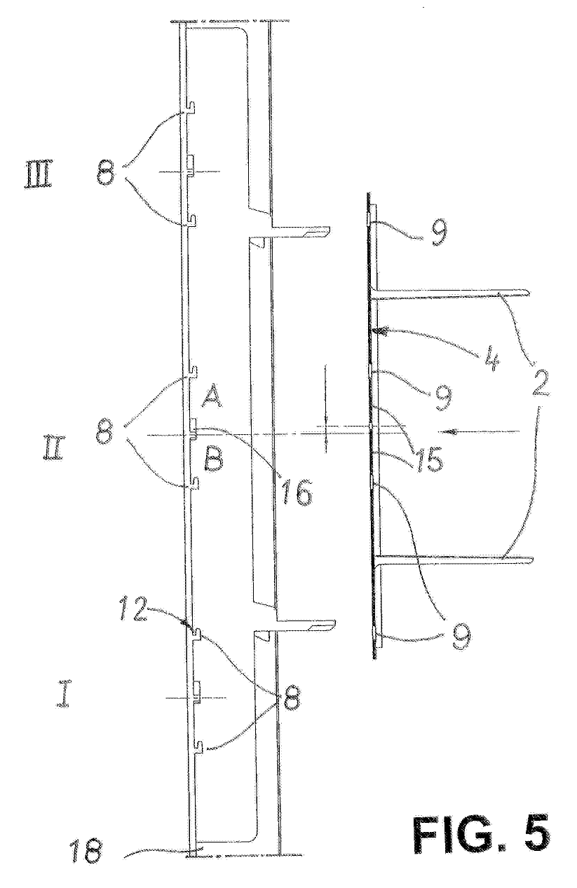

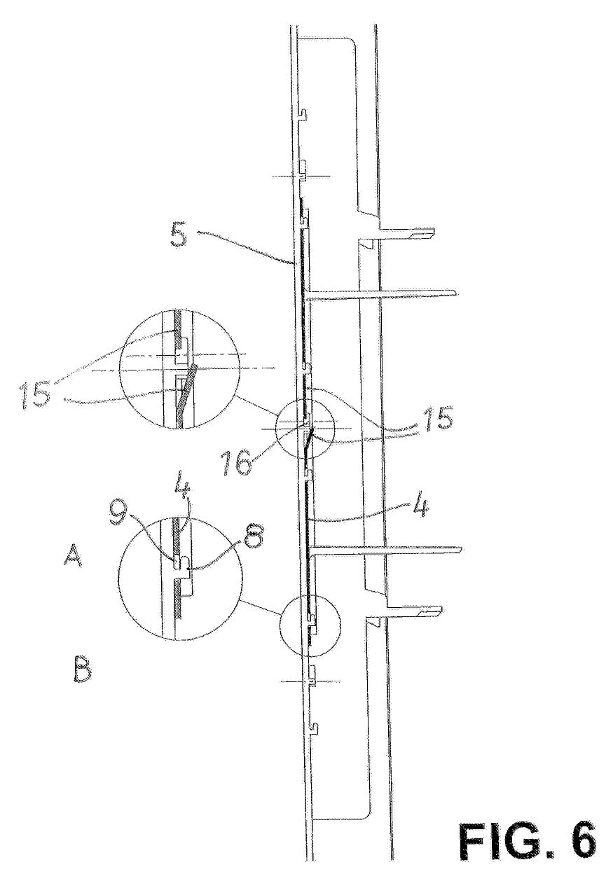

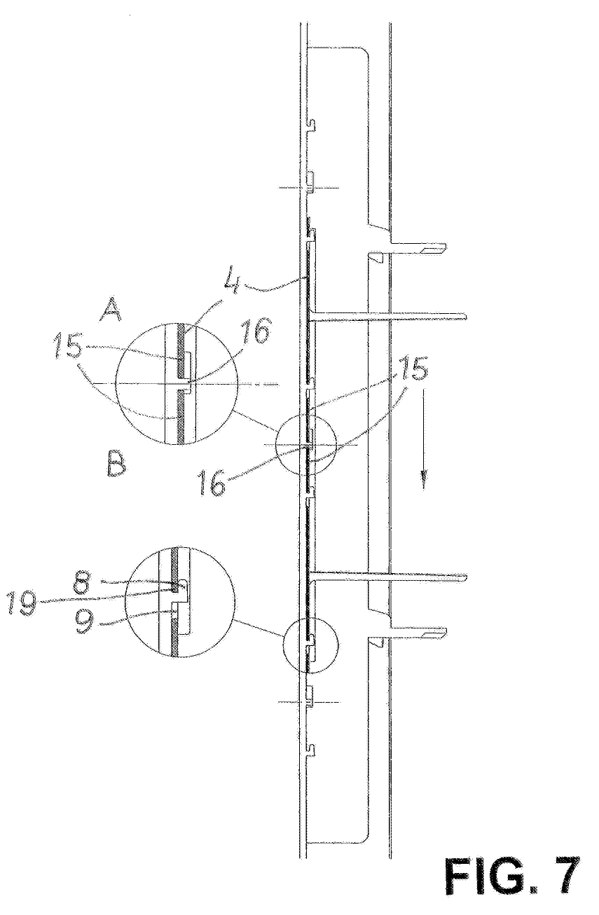

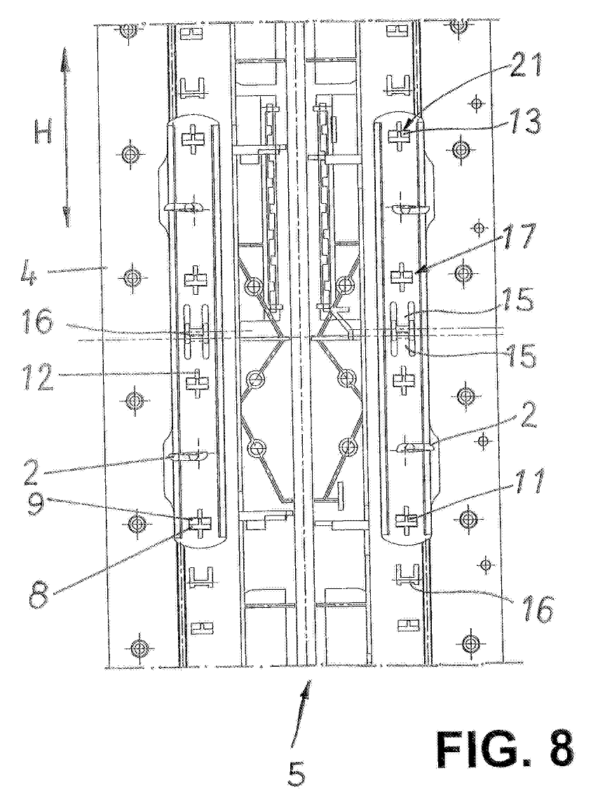

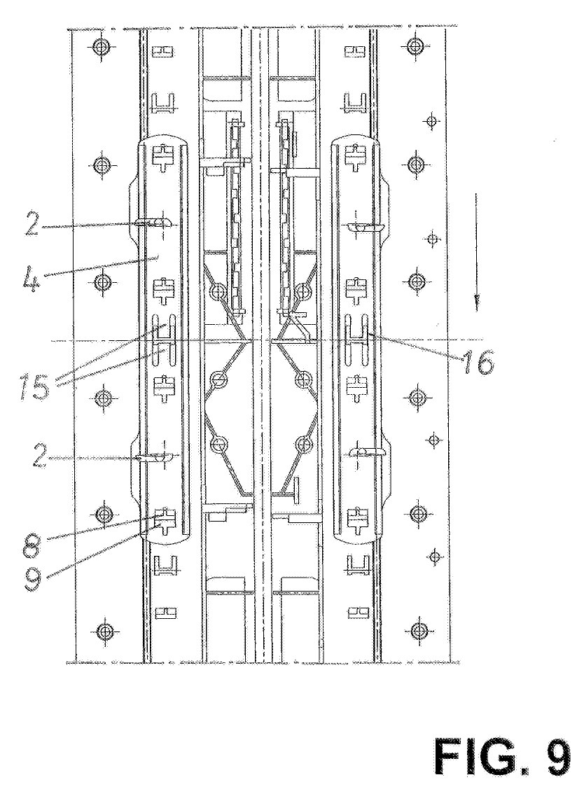

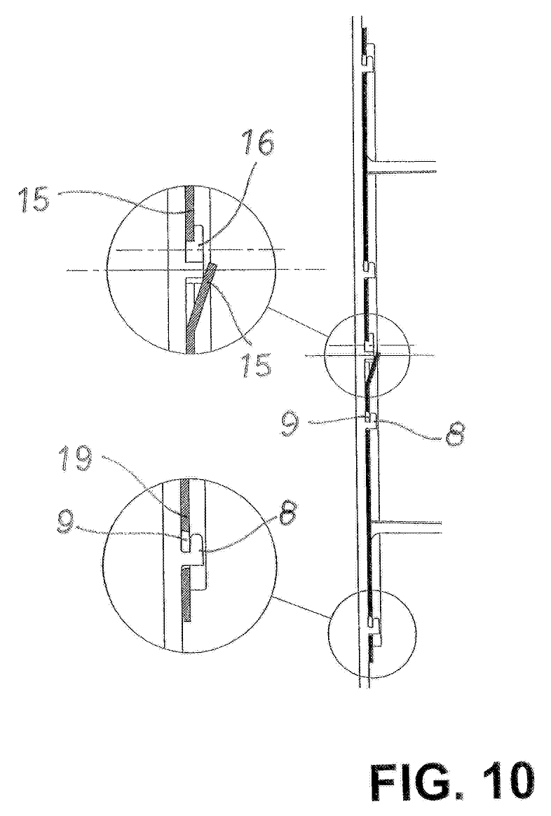

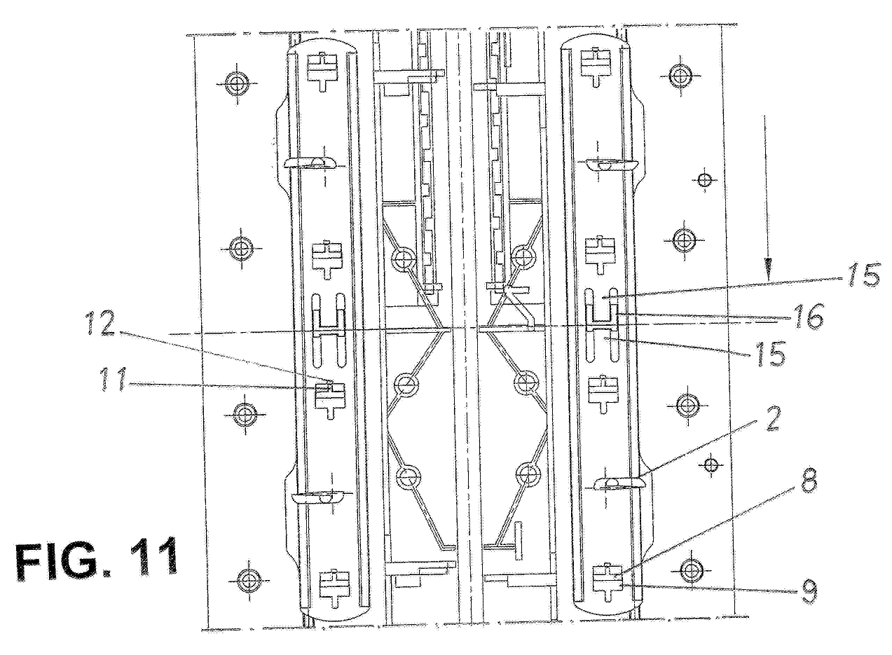

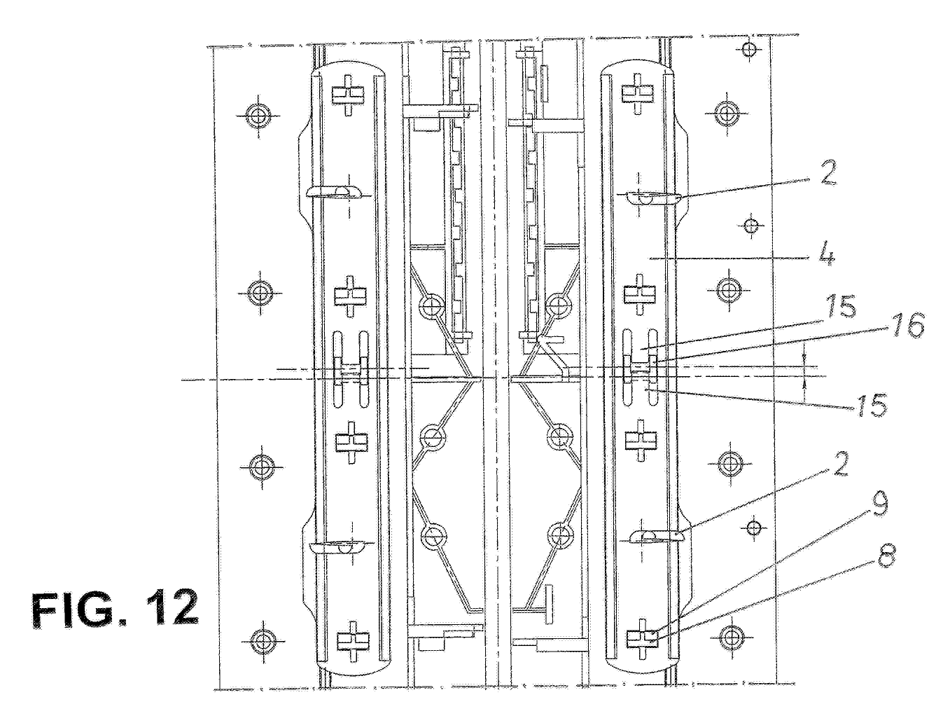

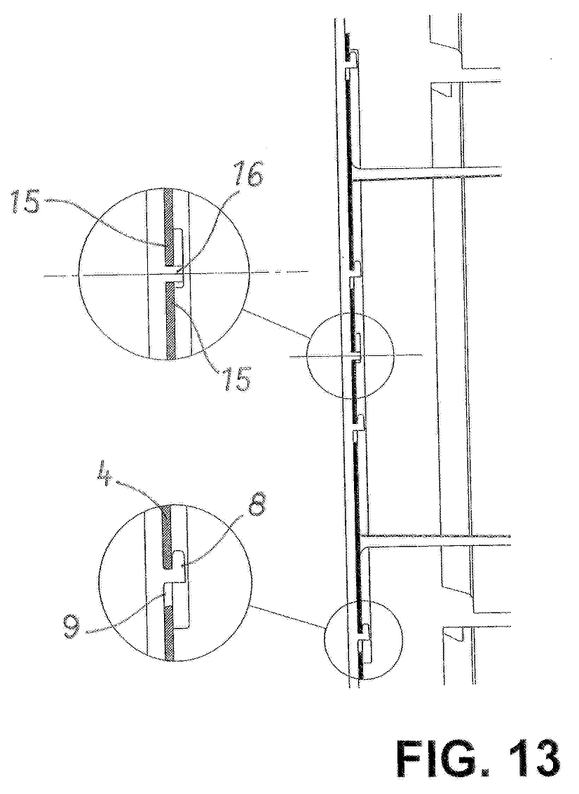

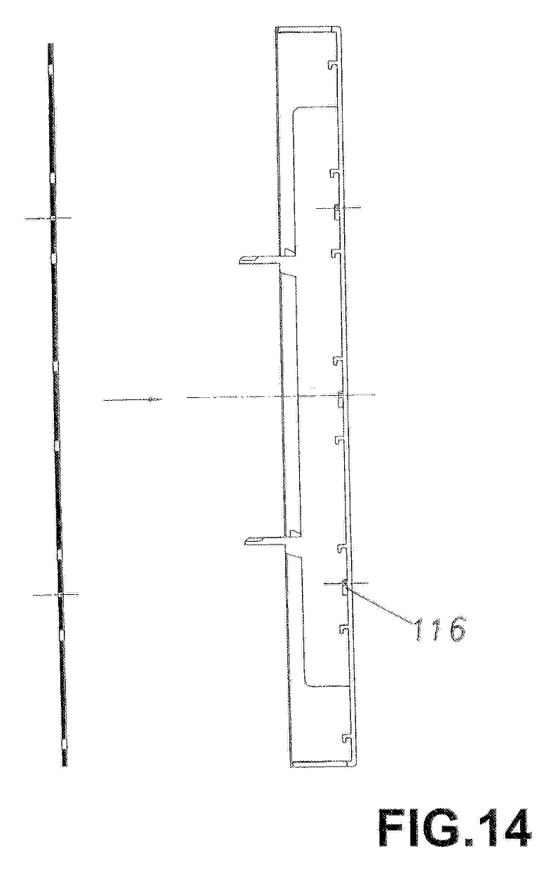

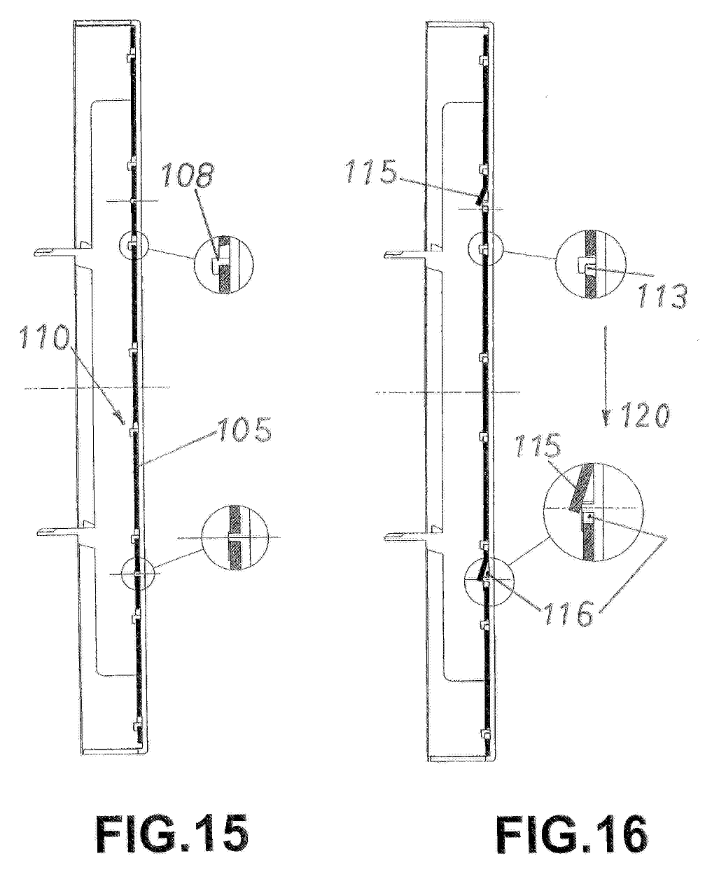

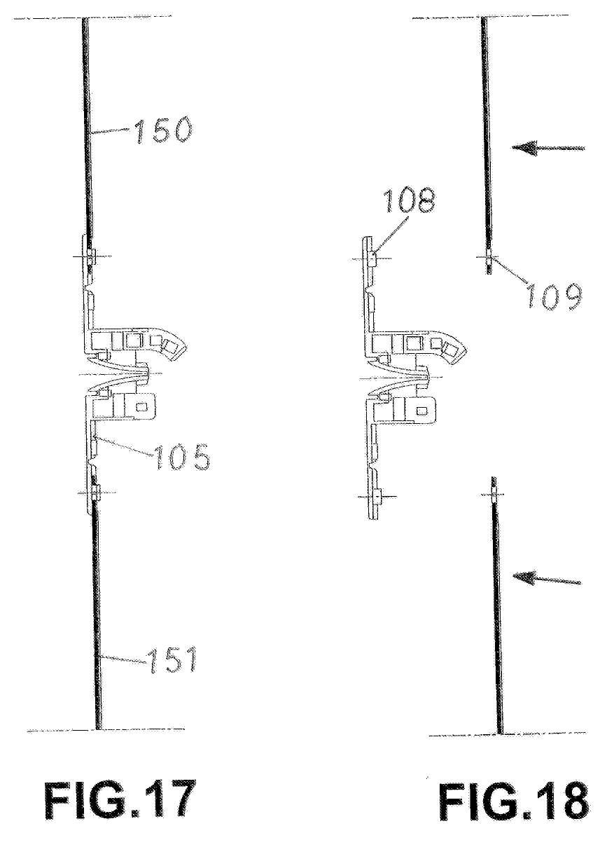

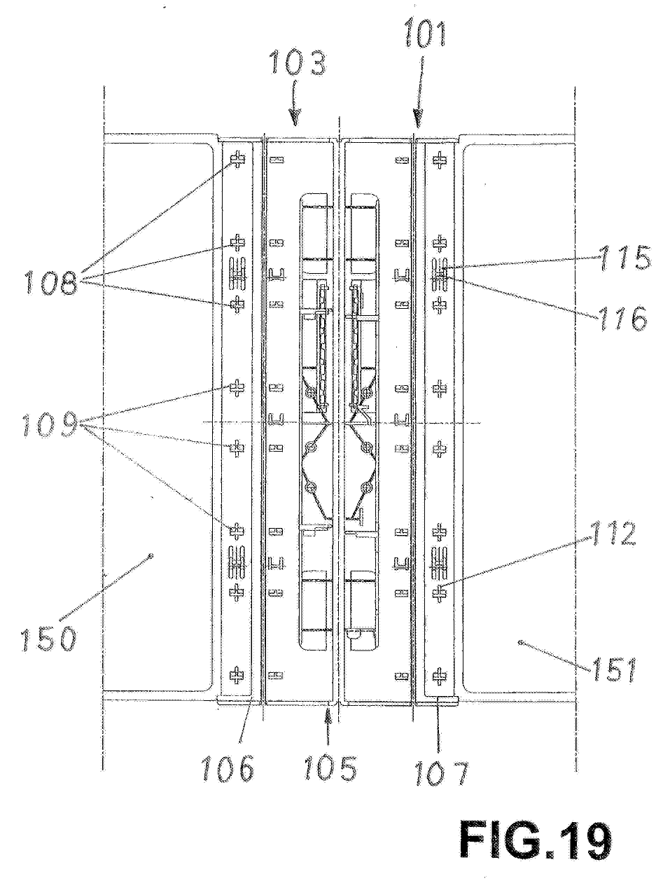

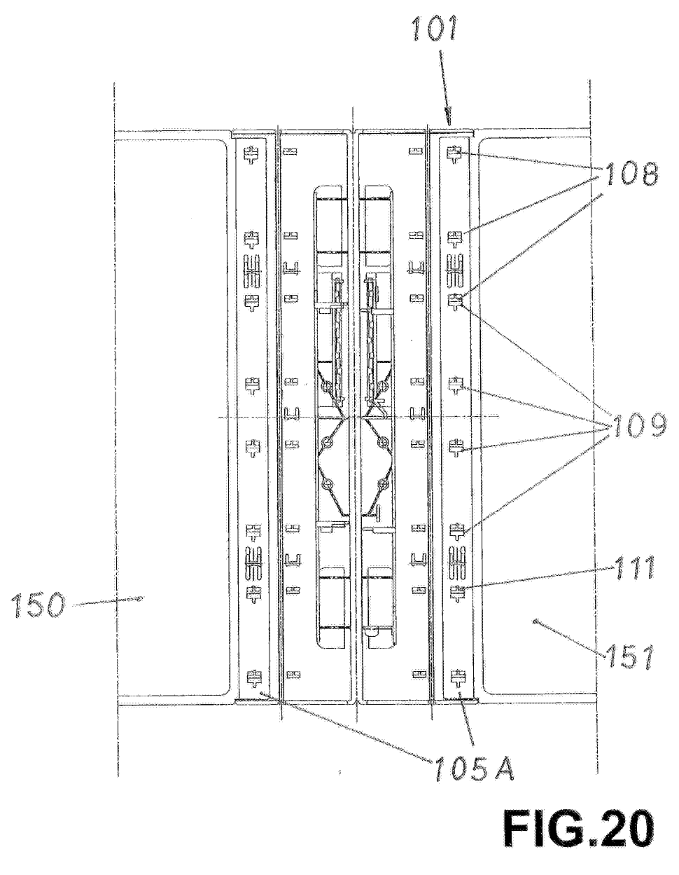

### DETAILED DESCRIPTION

A device 1, which is designed to secure prongs 2 in binders 3, and where prongs 2, which are designed to hold hole-punched paper, plastic pockets and the like in position in binder 3, are secured in groups to individual prong plates 4, which are in turn arranged to be secured to inner sections 6, 7 of a binder spine 5, comprises, according to the present invention, fastening mechanisms 8 and fastening means 9 arranged in a special manner. In more precise terms the fastening mechanisms 8 are arranged in a row 10, extending along the binder spine sections 6, 7, and the fastening mechanisms 8 are arranged so that they can be releasably connected to the fastening means 9 which are located on the respective prong plates 4 and which are supplementary to the fastening mechanisms 8.

Fastening mechanisms 8 and fastening means 9 consist of male and female couplings, and projecting hook-shaped fastening mechanisms 8, preferably secured to binder spine 5, are arranged to be received in hollow fastening means 9 arranged preferably in binder spine section 5A. To provide more effective securing, fastening mechanisms 8 each exhibit their own transverse ridge 11, which ridges are in turn receivable in a transverse opening 12 in the associated receiving fastening hole 9 intended for coupling, and which extend in upward direction 20 viewed in the intended vertical extension of the binder.

All hook-shaped fastening mechanisms 8 are directed with their openings 13 in common direction 12, viewed along the respective rows of fastening mechanisms 10 on binder spine 5.

Securing the prong mechanisms 14 is provided thanks to the presence of a number of sprung tongues 15 which are arranged on the prong plate 4 and which are arranged so that they receivably bear against their respective sides A and B about a common projecting receiving part 16, which is preferably H-shaped, or against their own separate receiving part now shown.

The fastening mechanisms 8 and fastening means 9 are formed by and/or in suitable plastic material, wherein fastening mechanisms 8, binder prongs 2 and prong plate 4 are formed on a common plastic part, whilst suitable fastening means 9 are formed on the plastic binder spine 5.

A device 1 according to the present invention, of the type indicated above, is suitable for use in assembling binders 3 with varying prong compositions to suit different standards of hole distances on paper, with associated prong compositions, or if the binder is required to be used as an archive box.

According to the invention fastening mechanisms 8 arranged in this case along binder spine sections 6, 7 are distributed along binder height H so that they enable the prong plates 4 to be positioned anywhere at the required level, viewed along the height H, along the binder spine 5, so that fastening mechanisms 8 and fastening means 9 oppose each other in pairs so that they interact with each other. This enables the couplings 17, interacting with each other in pairs, to continue to connect the required number of prong plates 4 at the required levels I, II, III . . . etc., counting from the lower edge section 18 of the binder.

The design and operation of the invention should be clear from the above, with particular reference to the drawings.

In summary it may be stated, however, that the required number of prong plates 4, which exhibit the correct prong pattern with projecting secured bent prong pins 2, are positioned in suitable order, preferably by machine, in front of row 10 with fastening mechanisms 8, after which the respective prong plates 4 and row of fastening mechanisms 10 are displaced relative to each other so that the preferably angular fastening mechanisms 8 are received by each of their hollow fastening means 9. Prong plate 4 and binder spine 5 are then displaced relative to each other so that fastening mechanisms 8 grip edge 19 on receiving fastening means 9. At the same time angled ridge 11 in respective fastening mechanisms 8 will be inserted in a suitable edge-located transverse opening 12 in fastening means 9 in question. When everything is in position in the intended fastening position the sprung tongues 15 snap in behind receiving part 16. Prong plate 4 is then secured with associated prong pins 2 effectively and firmly on the inside of the binder spine and can only be released after prizing open tongues 15 and pulling the same back in the opposite direction 20 indicated above.

Because the distances between fastening mechanisms 8 along the row 10 are selected carefully, the desired prong plates 4 can be placed in any fastening position along rows 10 so that prong plates 4 releasably secured in this case meet the standards of the intended countries regarding binders and hole punching. If the binders in question are required to be used for a different hole standard, prong plates 4 can be easily released and they can be replaced by others and/or moved up and/or down along row 10. Release takes place after prizing open one of locking tongues 15 from locking engagement with receiving part 16, and the prong plate in question is displaced so that angled fastening mechanisms 8 are released from engagement with fastening means 9 and their interacting edge sides 21. The entire binder and constituents parts can now also be recycled easily and environmentally safely because all the parts in the binder, or at least most of them, consist of the same material, namely plastic material.

A device 101, defined according to the further claims, is provided or fastening binder sides 150, 151 to binders 103, where binder sides 150, 151 are arranged to be fastened to the inner sections 106, 107 of the binder spine sections 106, 107. Arranged in rows 110 along the binder spine sections 106, 107 are fastening mechanisms 108, which are releasably connectable to supplementary fastening means 109 located on the respective binder sides 150, 151. Fastening mechanisms 108 and fastening means 109 consist of male and female couplings, wherein projecting hook-shaped fastening mechanisms 108, preferably secured to binder spine 105, are arranged to be received in hollow fastening means 109 preferably arranged in binder spine section 105A.

Fastening mechanisms 108 exhibit a transverse ridge 111, which is receivable in a transverse opening 112 in receiving fastening hole 109, and all the hook-shaped fastening mechanisms 108 are directed with their openings 113 in a common direction 120 viewed along the respective fastening mechanism rows 110 on binder spine 105. Sprung tongues 115 are arranged on binder side 150, 151, and bear receivably against either side of a projecting receiving part 116, which is preferably H-shaped. Fastening mechanisms 108 and fastening means 109 are formed of plastic material, wherein fastening mechanisms 108 are formed on the plastic binder spine 105. The binder sides 150, 151, and all the other parts preferably incorporated in binder 103, consist of a suitable plastic material, as a result of which the binder consists throughout of plastic material which allows environmentally friendly handling after use.

The invention is not of course limited to the embodiments described above and shown in the attached drawings. Modifications are possible, particularly in terms of the design of the different parts, or by the use of an equivalent method, without departing from the protective scope of the invention as defined in the claims.

What is claimed is:

1. A device for fastening prongs in binders, in which the prongs are secured to prong plates arranged to be fastened to inner sections of a binder spine, comprising:
fastening mechanisms arranged in rows along the binder spine sections;
hollow supplementary fastening devices located on respective prong plates; and
sprung tongues that are arranged on the prong plates and that receivably bear each of their sides against a projecting receiving part;
wherein the fastening mechanisms are releasably connectable to the supplementary fastening devices, are projecting hook-shaped, are secured to the binder spine, and are arranged to be received in the supplementary fastening devices; the fastening mechanisms are distributed along the prong plates adapted to a height (H) of the binder so that they can be positioned anywhere at a required level along the binder spine and so that the fastening mechanisms and fastening devices, interacting with each other, continue to connect a required number of prong plates at the required level; and the fastening mechanisms, sprung tongues, prongs, and prong plate are formed of plastic material on a common plastic part.

2. The device of claim 1, wherein the projecting receiving part is H-shaped.

3. The device of claim 1, wherein all hook-shaped fastening mechanisms are directed with their openings in a common direction, viewed along the respective fastening mechanism row on the binder spine.

4. The device of claim 1, wherein the fastening mechanisms and fastening devices include male and female couplings.

5. The device of claim 4, wherein all hook-shaped fastening mechanisms are directed with their openings in a common direction, viewed along the respective fastening mechanism row on the binder spine.

6. The device of claim 4, wherein the fastening mechanisms exhibit a ridge which is receivable in an opening in a receiving fastening hole.

7. The device of claim 6, wherein all hook-shaped fastening mechanisms are directed with their openings in a common direction, viewed along the respective fastening mechanism row on the binder spine.

8. A device for fastening sides to binders, where the sides are arranged to be fastened to inner sections of a binder spine, comprising:
fastening mechanisms arranged in rows along the binder spine sections;
hollow supplementary fastening devices located on the respective binder sides; and
sprung tongues, arranged on binder sides, receivably bear each of their sides against a projecting receiving part;
wherein the fastening mechanisms are releasably connectable to the supplementary fastening devices, are projecting hook-shaped, are secured to the binder spine, and are arranged to be received in fastening devices arranged in a binder spine section.

9. The device of claim 8, wherein the projecting receiving part is H-shaped.

10. The device of claim 8, wherein the fastening mechanisms exhibit a ridge which is receivable in an opening in a receiving hole.

11. The device of claim 8, wherein the fastening mechanisms and fastening devices include male and female couplings.

12. The device of claim 11, wherein the fastening mechanisms exhibit a ridge which is receivable in an opening in a receiving hole.

13. The device of claim 8, wherein all hook-shaped fastening mechanisms are directed with their openings in a common direction viewed along the respective fastening mechanism row on the binder spine.

14. The device of claim 8, wherein fastening mechanisms and fastening devices are formed of plastic material.

15. The device of claim 8, wherein fastening mechanisms are formed on the plastic binder spine.
